(19) United States
(12) Patent Application Publication
(10) Pub. No.: US 2024/0369773 A1
(43) Pub. Date: Nov. 7, 2024

(54) TWO-DIMENSIONAL GRATING, OPTICAL WAVEGUIDE AND AR EYEWEAR

(71) Applicant: Beijing Zitiao Network Technology Co., Ltd., Beijing (CN)

(72) Inventor: Wen XIONG, Beijing (CN)

(21) Appl. No.: 18/655,994

(22) Filed: May 6, 2024

(30) Foreign Application Priority Data
May 6, 2023 (CN) 202310506845.7

(51) Int. Cl. G02B 6/34; G02B 5/18; G02B 6/12; G02B 6/124; G02B 27/01

(52) U.S. Cl. CPC G02B 6/34; G02B 5/1861; G02B 6/124; G02B 27/0172; G02B 2006/12107

(57) ABSTRACT

Provided in the present disclosure are a two-dimensional grating, an optical waveguide, and an AR eyewear. The two-dimensional grating includes a plurality of sub-units, wherein the plurality of sub-units are arranged at intervals along a first direction, and the plurality of sub-units are arranged at intervals along a second direction, a set angle exists between the first direction and the second direction, and an angular bisector direction of the set angle coincides with a diffraction order direction required to be suppressed by the two-dimensional grating; projections of two adjacent sub-units in any one of the first direction and the second direction in a direction perpendicular to the diffraction order direction are connected to each other and not overlapped. In a display process of the optical waveguide, diffraction orders of the two-dimensional grating that need to be suppressed can be suppressed, so that appearing of central bright streaks in the optical waveguide display may be effectively suppressed, thereby display uniformity of the optical waveguide may be improved.

### CROSS REFERENCE TO RELATED APPLICATION(S)

The present application claims priority to Chinese Application No. 2023105068457 filed on May 6, 2023, the disclosure of which is incorporated herein by reference in its entity.

### FIELD

Embodiments of the present disclosure relate to the field of optical technologies, and in particular to, a two-dimensional grating, an optical waveguide, and an AR eyewear.

### BACKGROUND

An augmented Reality (AR) eyewear based on an optical waveguide is one of AR eyewear with wide application prospect. Working principle of emergent-pupil replication of an optical waveguide is key for implementing consumer-grade AR eyewear, and is one of core components for implementing lightweight AR eyewear.

In related art, a circle with a solid dot in FIG. 1 represents light coupling-out, and a line with an arrow represents extension propagation. As shown in FIG. 1, an optical waveguide includes an optical waveguide sheet 1, the optical waveguide sheet 1 includes a coupling-in region 2 and a coupling-out region 3, the coupling-in region 2 is provided with a one-dimensional grating, the coupling-out region 3 is provided with a two-dimensional grating, the one-dimensional grating couples light emitted by an optical machine into the optical waveguide sheet, then the light is incident onto the two-dimensional grating via total reflection, and under action of the two-dimensional grating, the light is expanded or coupled out along a plurality of diffraction order directions. FIG. 2 shows diffraction orders of the two-dimensional grating, including (0,1)-order diffraction order, (1,0)-order diffraction order, (1,1)-order diffraction order.

However, in a display process of the optical waveguide, there is a phenomenon that central bright streaks appear in the optical waveguide display, and the optical waveguide has a problem of poor display uniformity.

### SUMMARY

Embodiments of the present disclosure provide a two-dimensional grating, an optical waveguide, and an AR eyewear, so as to overcome a phenomenon that central bright streaks appear in an optical waveguide display in a display process of the optical waveguide, and a problem of poor display uniformity that the optical waveguide has.

According to a first aspect, embodiments of the present disclosure provide a two-dimensional grating including a plurality of sub-units, wherein the plurality of sub-units are arranged at intervals along a first direction and the plurality of sub-units are arranged at intervals along a second direction, a set angle exists between the first direction and the second direction, and an angular bisector direction of the set angle coincides with a diffraction order direction required to be suppressed by the two-dimensional grating;
projections of two adjacent sub-units in any one of the first direction and the second direction in a direction perpendicular to the diffraction order direction are connected to each other and not overlapped.

According to a second aspect, embodiments of the present disclosure provide an optical waveguide, including an optical waveguide sheet, where the optical waveguide sheet includes a coupling-in region and a coupling-out region; the coupling-out region is provided with a two-dimensional grating as described above.

According to a third aspect, embodiments of the present disclosure provide an AR spectacle, comprising a spectacle frame;
at least one optical waveguide as described above, wherein the optical waveguide sheet of the optical waveguide is embedded in the spectacle frame.

Provided in embodiments of the present disclosure are a two-dimensional grating, an optical waveguide, and an AR eyewear. The two-dimensional grating includes a plurality of sub-units, wherein the plurality of sub-units are arranged at intervals along a first direction, and the plurality of sub-units are arranged at intervals along a second direction, a set angle exists between the first direction and the second direction, and an angular bisector direction of the set angle coincides with a diffraction order direction required to be suppressed by the two-dimensional grating; projections of two adjacent sub-units in any one of the first direction and the second direction in a direction perpendicular to the diffraction order direction are connected to each other and not overlapped. In a display process of the optical waveguide, diffraction orders of the two-dimensional grating that need to be suppressed can be suppressed, so that appearing of central bright streaks in the optical waveguide display may be effectively suppressed, thereby display uniformity of the optical waveguide may be improved.

### BRIEF DESCRIPTION OF THE DRAWINGS

To describe technical solutions in embodiments of the present disclosure or in prior art more clearly, following briefly introduces drawings required for describing the embodiments or the prior art, apparently, the drawings in following description show some embodiments of the present disclosure. Other drawings may also be obtained according to these drawings without creative efforts.

FIG. 1 is a schematic diagram of light propagation of an AR eyewear after being coupled out by a two-dimensional grating in related art;

FIG. 2 is a schematic diagram of diffraction order of a two-dimensional grating in FIG. 1;

FIG. 3 is a variation regularity schematic diagram of diffraction efficiency of a two-dimensional grating in FIG. 1;

FIG. 4 is a display schematic diagram of an optical waveguide of an AR eyewear shown in FIG. 1;

FIG. 5 is a structural schematic diagram of a first two-dimensional grating provided by embodiments of the present disclosure;

FIG. 6 is a partial structural schematic diagram of a two-dimensional grating in FIG. 5;

FIG. 7 is a partial structural schematic diagram of a second two-dimensional grating provided by embodiments of the present disclosure;

FIG. 8 is a partial structural schematic diagram of a third two-dimensional grating provided by embodiments of the present disclosure;

FIG. 9 is a partial structural schematic diagram of a fourth two-dimensional grating provided by embodiments of the present disclosure;

FIG. 10 is a partial structural schematic diagram of a fifth two-dimensional grating provided by embodiments of the present disclosure;

FIG. 11 is a variation regularity schematic diagram of a diffraction efficiency of a two-dimensional grating in FIG. 5;

FIG. 12 is a display schematic diagram of an optical waveguide of an AR eyewear provided by embodiments of the present disclosure.

### REFERENCE SIGNS

1 optical waveguide sheet;
2 coupling-in region;
3 coupling-out region;
10 sub-unit;
11 long side;
12 short side;
a1 first direction;
a2 second direction;
a3 angular bisector direction.

### DETAILED DESCRIPTION

In order to make the purpose, technical solution and advantages of embodiments of the present disclosure clearer, the technical solutions in the embodiments of the present disclosure will be clearly and completely described below in conjunction with drawings in the embodiments of the present disclosure, and it is obvious that embodiments described are part of the embodiments of the present disclosure, not all embodiments. Based on the embodiments in the present disclosure, all other embodiments obtained by those skilled in art without creative efforts fall within scope of protection of the present disclosure.

It should be noted that terms ‘first’ and ‘second’ are used for descriptive purposes only and should not be construed as indicating or implying relative importance or implying the number of technical features indicated. Thus, features that are defined as ‘first’ and ‘second’ may explicitly or implicitly include at least one of these features. In description of this disclosure, ‘multiple’ means at least two, such as two, three, etc., unless otherwise expressly and specifically qualified.

In the present disclosure, unless otherwise expressly specified or qualified, terms ‘mounted’, ‘connected’, ‘fixed’, etc., shall be construed broadly, for example, as fixed connection, detachable connection, or integral, mechanically, electrically or communicatively, directly or indirectly through an intermediary, or within two elements or in an interactive relationship, unless otherwise expressly specified. For person of those skilled in art, specific meaning of above terms in the present disclosure may be understood on a case-by-case basis.

In the present disclosure, unless otherwise expressly specified and qualified, a first feature is ‘above’ or ‘below’ a second feature may be direct contact with the first and second features, or indirect contact between the first and second features through an intermediary. Moreover, the first feature is ‘above’, ‘on top of’, and ‘on topmost of’ the second feature may be that the first feature is directly above or obliquely above the second feature, or simply indicating that horizontal height of the first feature is higher than the second feature. The first feature is ‘below’, ‘under’, and ‘on bottom of’ the second feature may be that the first feature is directly below or diagonally below the second feature, or simply indicating that horizontal height of the first feature is less than the second feature.

In above description, reference terms ‘one embodiment’, ‘some embodiments’, ‘an example’, ‘a specific example’ or ‘some examples’ means that a particular feature, structure, material, or characteristic described in connection with the embodiment or example is included in at least one embodiment or example of the present disclosure. Thus, appearances of the phrases in various places throughout this description are not necessarily referring to the same embodiment or example of the present disclosure. Furthermore, particular features, structures, materials, or characteristics described may be combined in any suitable manner in one or more embodiments or examples. In addition, those skilled in art can combine and compose different embodiments or examples and features of the different embodiments or examples described in description without conflicting with each other.

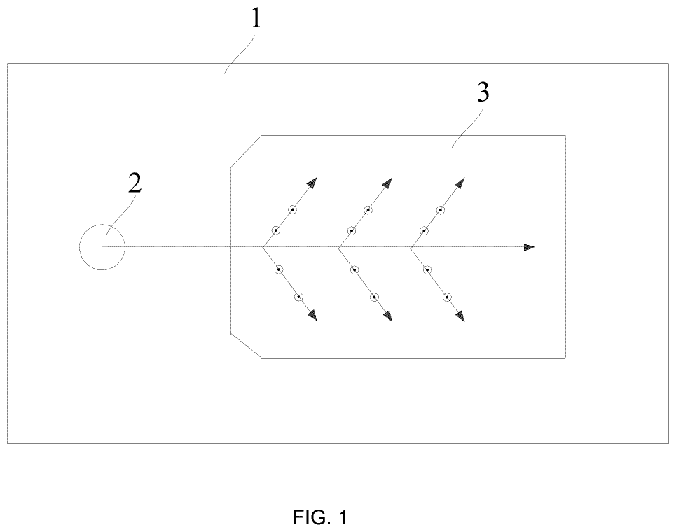

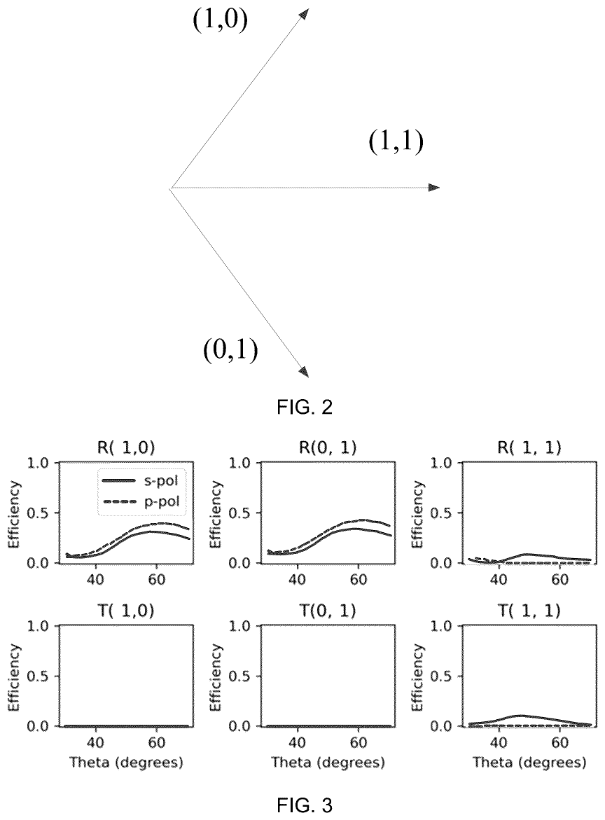

In related art, a circle with a solid dot in FIG. 1 represents light coupling-out, and a line with an arrow represents extension propagation. As shown in FIG. 1, an optical waveguide includes an optical waveguide sheet 1, the optical waveguide sheet 1 includes a coupling-in region 2 and a coupling-out region 3, the coupling-in region 2 is provided with a one-dimensional grating, the coupling-out region 3 is provided with a two-dimensional grating, and the one-dimensional grating couples light emitted by an optical machine into the optical waveguide sheet, then the light is incident onto the two-dimensional grating via total reflection, and under action of the two-dimensional grating, the light is expanded or coupled out along a plurality of diffraction order directions. FIG. 2 shows diffraction orders of the two-dimensional grating, including (0,1)-order diffraction order, (1,0)-order diffraction order, (1,1)-order diffraction order. However, in display process of the optical waveguide, only the (0,1)-order diffraction order and the (1,0)-order diffraction order are required, and existence of the (1,1)-order diffraction order causes a phenomenon that central bright streaks appear in the optical waveguide display, resulting in poor display uniformity of the optical waveguide.

The diffraction order direction is a propagation direction of the light under action of the two-dimensional grating. The (0,1) order diffraction order direction, (1,0) order diffraction order direction, and (1,1) order diffraction order direction are three propagation directions of the light under action of the two-dimensional grating.

In order to solve above-described problem, embodiments of the present disclosure provide a two-dimensional grating, an optical waveguide and an AR eyewear. By means of two adjacent sub-units in any one of a first direction and a second direction of the two-dimensional grating, projections in a direction perpendicular to a diffraction order direction required to be suppressed by the two-dimensional grating are connected to each other and not overlapped. In a display process of an optical waveguide, diffraction orders of a two-dimensional grating that need to be suppressed can be suppressed, so that appearing of central bright streaks in the optical waveguide display may be effectively suppressed, thereby display uniformity of the optical waveguide may be improved.

Detailed description will be given below to the two-dimensional grating, the optical waveguide and the AR eyewear provided by embodiments of the present disclosure with reference to specific embodiments.

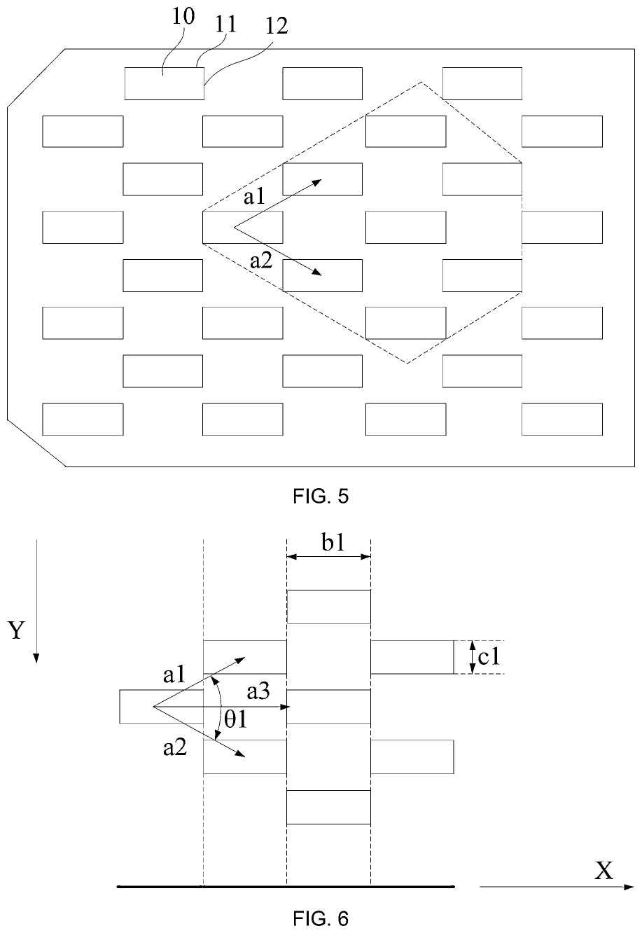

FIG. 5 is a structural schematic diagram of a first two-dimensional grating provided by embodiments of the present disclosure; FIG. 6 is a partial structural schematic diagram of a two-dimensional grating in FIG. 3, a portion surrounded by dotted lines in FIG. 5 is a partial structure of a two-dimensional grating in FIG. 6, and black solid lines extending along a X direction in FIG. 6 are projections of the sub-units 10 in a Y direction in FIG. 6.

As shown in FIGS. 5 and 6, embodiments of the present disclosure provide a two-dimensional grating, including a plurality of sub-units 10, wherein the plurality of sub-units 10 are arranged at intervals along a first direction a1, and the plurality of sub-units are arranged at intervals along a second direction a2; projections of two adjacent sub-units in any one of the first direction a1 and the second direction a2 in a direction perpendicular to a diffraction order direction required to be suppressed by the two-dimensional grating are connected to each other and not overlapped.

A set angle exists between the first direction a1 and the second direction a2, and an angular bisector direction a3 of the set angle coincides with a diffraction order direction required to be suppressed by the two-dimensional grating. In this embodiment, the diffraction order direction to be suppressed by the two-dimensional grating may be a (1,1)-order diffraction order direction.

In FIG. 6, a direction indicated by an arrow X is the (1,1)-order diffraction order direction of the two-dimensional grating, and a direction indicated by an arrow Y is a direction perpendicular to the (1,1)-order diffraction order direction of the two-dimensional grating.

A set angle between the first direction a1 and the second direction a2 may be set as required.

A refractive index of the sub-units 10 is different from a refractive index of other parts of the two-dimensional grating. Specifically, the other parts of the two-dimensional grating are remaining parts of the two-dimensional grating after all the sub-units 10 are removed.

In the Y direction, projections of two adjacent sub-units 10 in the Y direction coincide, that is, in a direction perpendicular to the angular bisector a3, projections of two adjacent sub-units 10 in the Y direction coincide.

Projections of two adjacent sub-units 10 in any one of the first direction a1 and the second direction a2 in a direction perpendicular to a (1,1)-order diffraction order direction of the two-dimensional grating are connected to each other and not overlapped, that is, projections of two adjacent sub-units 10 in any one of the first direction a1 and the second direction a2 in the Y direction are connected to each other and not overlapped. Specifically, projections of two adjacent sub-units 10 in the first direction a1 along the Y direction include two projections, the two projections are not overlapped, and the two projections are connected in a X direction; Projections of two adjacent sub-units 10 in the second direction a2 along the Y direction include two projections, the two projections are not overlapped, and the two projections are connected to each other in the X direction.

It should be noted that the first direction a1, the second direction a2, the X direction, and the Y direction are in the same plane.

According to the two-dimensional grating provided by embodiments of the present disclosure, by means of two adjacent sub-units 10 in any one of the first direction a1 and the second direction a2 of the two-dimensional grating are provided, projections in a direction perpendicular to the diffraction order direction required to be suppressed by the two-dimensional grating are connected to each other and not overlapped, in a display process of the optical waveguide, diffraction orders of the two-dimensional grating that need to be suppressed can be suppressed, so that appearing of central bright streaks in the optical waveguide display may be effectively suppressed, thereby display uniformity of the optical waveguide may be improved.

Alternatively, as shown in FIG. 5, each of the sub-units 10 is a rectangular sub-unit including a long side 11 and a short side 12 perpendicular to each other. In other ways, the sub-units 10 may also be a sub-unit with other shapes, and by means of two adjacent sub-units with the shape in any one of the first direction a1 and the second direction a2 of the two-dimensional grating, projections in a direction perpendicular to the diffraction order direction required to be suppressed of the two-dimensional grating are connected to each other and not overlapped.

The long side 11 is parallel to the (1,1)-order diffraction order direction of the two-dimensional grating, that is, the long side 11 is parallel to the X direction.

Length of the long side 11 may be greater than length of the short side 12.

Unit cell shape of a crystal lattice of the two-dimensional grating is rectangular, and refractive index of the sub-units 10 is different from that of other parts of the two-dimensional grating. Specifically, the refractive index of the sub-units 10 may be less than the refractive index of other parts of the two-dimensional grating, and may also be greater than the refractive index of other parts of the two-dimensional grating.

In an optional implementation, refractive indexes of all sub-units 10 of the two-dimensional grating are equal, and the refractive index of the sub-units 10 is less than that of other parts of the two-dimensional grating.

In another optional implementation, refractive indexes of all sub-units 10 of the two-dimensional grating are equal, and the refractive index of the sub-units 10 is greater than that of other parts of the two-dimensional grating.

Further, projections of long sides 11 of two adjacent sub-units 10 in any one of the first direction a1 and the second direction a2 in perpendicular to the (1,1)-order diffraction order direction of the two-dimensional grating are connected to each other and not overlapped. Specifically, projections of long edges 11 of two adjacent sub-units 10 in the first direction a1 along the Y direction include two projections, the two projections are not overlapped, and in the X direction, the two projections are connected; Projections of long edges 11 of two adjacent sub-units 10 in the second direction a2 along the Y direction include two projections, the two projections are not overlapped, and the two projections are connected in the X direction.

Two adjacent sub-units 10 in any one of the first direction a1 and the second direction a2 are arranged at equal intervals. Specifically, two adjacent sub-units 10 in the first direction a1 are arranged at equal intervals, and two adjacent sub-units 10 in the second direction a2 are arranged at equal intervals.

Optionally, as shown in FIGS. 5 and 6, lengths of long sides 11 of any two sub-units 10 are equal, and lengths of short sides 12 of any two sub-units 10 are equal. In other ways, two sub-units 10 with different lengths of long sides 11 may exist in the two-dimensional grating, or two sub-units 10 with different lengths of short sides 12 may exist in the two-dimensional grating.

Length of the long side 11 of the sub-units 10 may be set according to requirements, and length of the short side 12 of the sub-units 10 may be set according to requirements.

In the (1,1)-order diffraction order direction of the two-dimensional grating, distance between two adjacent sub-units 10 is equal to length of the long side 11 of the sub-units 10, that is, in the X direction, distance between two adjacent sub-units 10 is equal to length of the long side 11 of the sub-units 10.

In the first optional implementation, as shown in FIG. 6, length of the long side 11 of any sub-units 10 is b1, and length of the short side 12 of any sub-units 10 is c1.

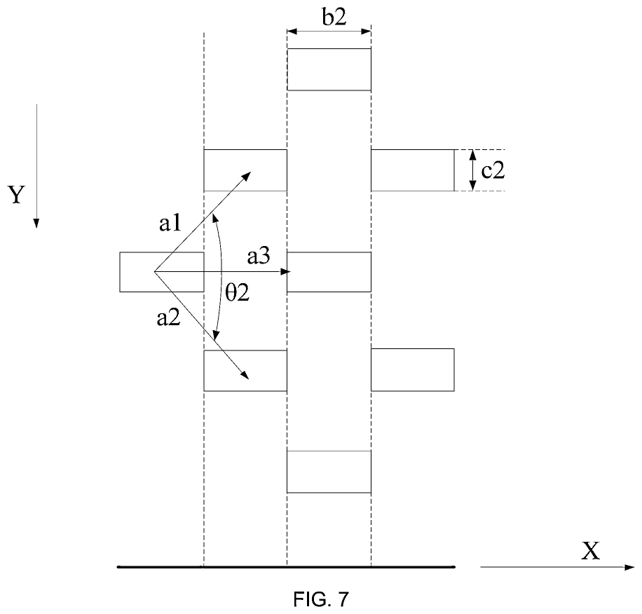

FIG. 7 is a partial structural schematic diagram of a second two-dimensional grating provided by embodiments of the present disclosure.

In a second optional implementation, as shown in FIG. 7, lengths of long sides 11 of any sub-units 10 are b2, b2=b1, lengths of short sides 12 of any sub-units 10 are c2, c2>c1.

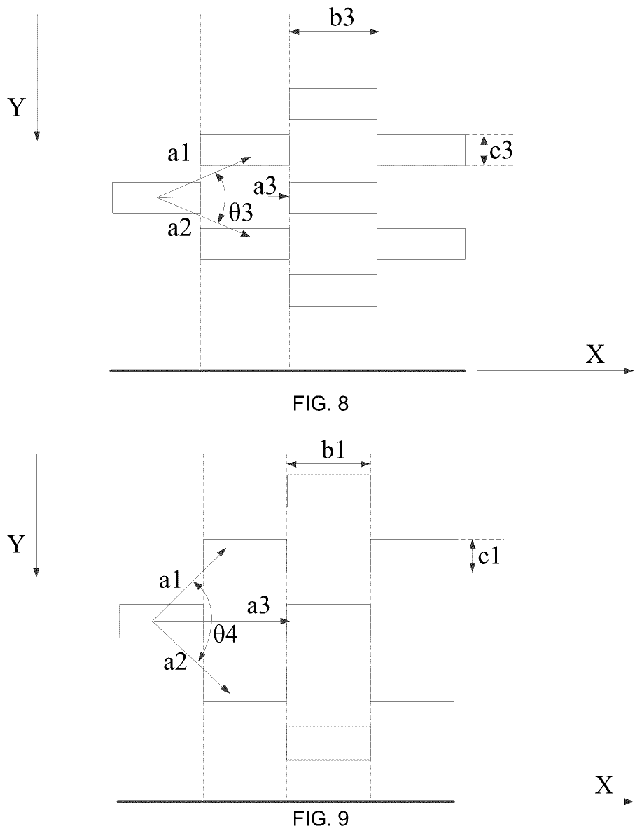

FIG. 8 is a partial structural schematic diagram of a third two-dimensional grating provided by embodiments of the present disclosure.

In a third optional implementation, as shown in FIG. 8, length of a long side 11 of any of the sub-units 10 is b3, b3>b1, and length of a short side 12 of any of the sub-units 10 is c3, c3<c1.

Alternatively, a first direction a1 and a second direction a2 may be directions of two lattice vectors of lattices of the two-dimensional grating.

An angle between the first direction a1 and the second direction a2 is 0° to 180°.

In a first optional implementation, as shown in FIG. 6, length of the long side 11 of any of the sub-units 10 is b1, length of the short side 12 of any of the sub-units 10 is c1, and a set angle between the first direction a1 and the second direction a2 is θ1, θ1<90°.

In a second optional implementation, as shown in FIG. 7, lengths of the long sides 11 of any sub-units 10 are b2, b2=b1, lengths of the short sides 12 of any sub-units 10 are c2, c2>c1, and a set angle between a first direction a1 and a second direction a2 is θ2, θ2>90°.

In a third optional implementation, as shown in FIG. 8, length of the long side 11 of any of the sub-units 10 is b3, b3>b1, length of the short side 12 of any of the sub-units 10 is c3, c3<c1, and the set angle between the first direction a1 and the second direction a2 is θ3, θ3<θ1.

In a fourth optional implementation, as shown in FIG. 9, length of a long side 11 of any sub-units 10 is b1, length of a short side 12 of any sub-units 10 is c1, a set angle between a first direction a1 and a second direction a2 is θ4, θ4>θ1, and θ4 is equal to 90°.

Alternatively, the (1,1)-order diffraction order direction of the two-dimensional grating may be an arbitrary direction.

In an optional implementation, as shown in FIG. 6, the (1,1)-order diffraction order direction of the two-dimensional grating is a horizontal direction, that is, the X direction is a horizontal direction. Length of the long side 11 of any two sub-units 10 is b1, length of the short side 12 of any two sub-units 10 is c1, and the set angle between the first direction a1 and the second direction a2 is θ1.

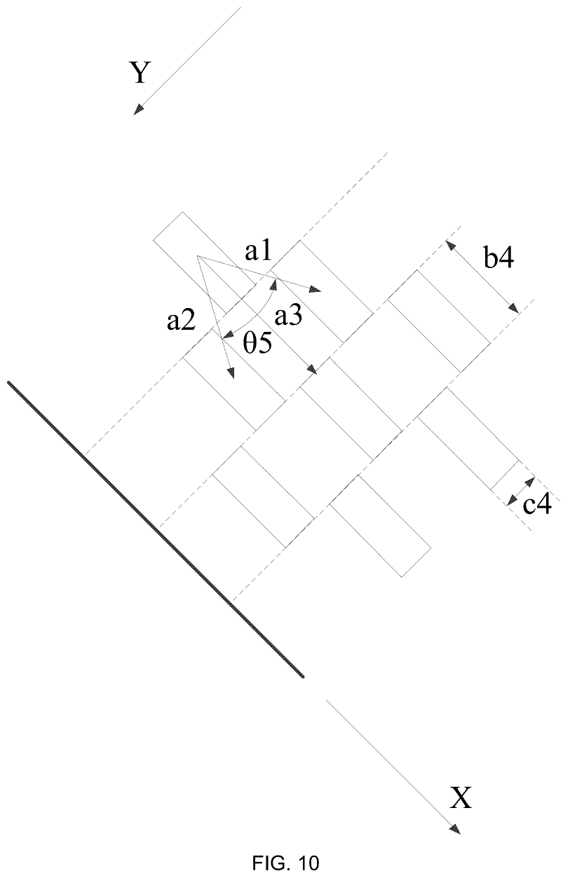

FIG. 10 is a partial structural schematic diagram of a fifth two-dimensional grating provided by embodiments of the present disclosure.

In another optional implementation, as shown in FIG. 10, a (1,1)-order diffraction order direction of a two-dimensional grating may be inclined to a horizontal direction, and may also be perpendicular to the horizontal direction, that is, a X direction may be inclined to the horizontal direction, and may also be perpendicular to the horizontal direction. lengths of long sides 11 of any two sub-units 10 are b4, b4=b1, lengths of short sides 12 of any two sub-units 10 are c4, c4=c1, and a set angle between a first direction a1 and a second direction a2 is θ5, θ5=θ1.

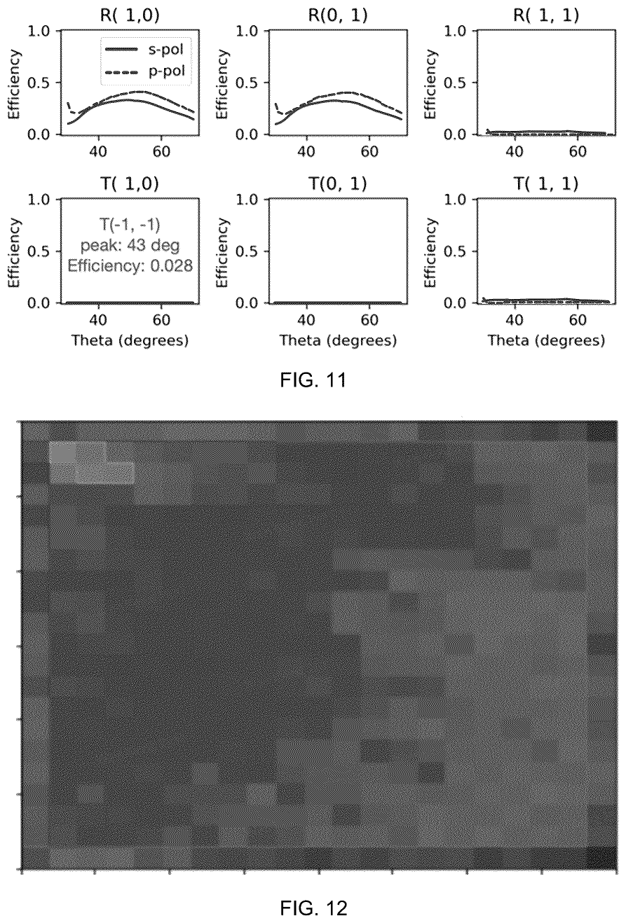

FIG. 3 is a variation regularity schematic diagram of a diffraction efficiency of a two-dimensional grating in FIG. 1, and FIG. 11 is a variation regularity schematic diagram of a diffraction efficiency of a two-dimensional grating in FIG. 5. Horizontal axis in FIGS. 3 and 10 is an angle at which light enters the two-dimensional grating, and vertical axis is the diffraction efficiency. Upper three diagrams in FIGS. 3 and 11 are the variation regularity of the diffraction efficiency of the two-dimensional grating in (1,0)-order diffraction order, (0,1)-order diffraction order, and (1,1)-order diffraction order directions when the two-dimensional grating is a reflection grating; Lower three graphs in FIGS. 3 and 11 show the variation regularity of the diffraction efficiency of the two-dimensional grating in the (1,0)-order diffraction order, the (0,1)-order diffraction order, and the (1,1)-order diffraction order directions when the two-dimensional grating transmits the grating. Comparing the diffraction efficiency in the (1,1)-order diffraction order direction in FIG. 3 with that in the (1,1)-order diffraction order direction in FIG. 10, it can be seen that the diffraction efficiency in the (1,1)-order diffraction order direction in FIG. 11 is almost 0; therefore, in display process of an optical waveguide, the two-dimensional grating (1,1)-order diffraction order can be suppressed.

Provided in an embodiment of the present disclosure is an optical waveguide, including an optical waveguide sheet, wherein the optical waveguide sheet includes a coupling-in region and a coupling-out region; The coupling-out region is provided with a two-dimensional grating.

The two-dimensional grating in this embodiment has the same structure as the two-dimensional grating provided in any one of above-described embodiments, and can bring about the same or similar technical effects. Details are not repeatedly described herein. For details, reference may be made to description of the above-described embodiments.

Shape of the coupling-in region may be regular or irregular, and shape of the coupling-out region may be regular or irregular.

The coupling-in region can be set at an edge of any side of the coupling-out region, and the positions of the coupling-in region and the coupling-out region on the optical waveguide can be set according to actual needs.

In an optional implementation, shape of the coupling-in region is a circle, the coupling-out region is a notch rectangle, the notch rectangle has two notches, the coupling-in region is set at one side of the notch rectangle, notches of the notch rectangle are set close to the coupling-in region, the coupling-in region is provided with a one-dimensional grating, and the coupling-out region is provided with a two-dimensional grating.

In another optional implementation, shape of the coupling-in region is circular, shape of the coupling-out region is rectangular, the coupling-in region is disposed at any one side of the coupling-out region, top, bottom, left and right sides of the coupling-in region, the coupling-in region is provided with a one-dimensional grating, and the coupling-out region is provided with a two-dimensional grating.

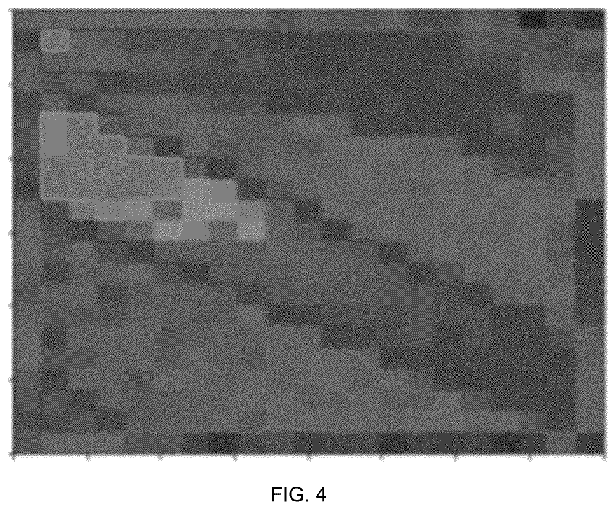

FIG. 4 is a display schematic diagram of an optical waveguide of an AR eyewear in related art. FIG. 12 is a display schematic diagram of an optical waveguide of an AR eyewear provided by embodiments of the present disclosure. Central bright streaks appear in FIG. 4, while there are no central bright streaks in FIG. 11, that is, the central bright streaks are effectively suppressed from appearing in the optical waveguide by using a two-dimensional grating in the present embodiment, thereby display uniformity of the optical waveguide may be improved.

It should be noted that FIGS. 4 and 12 are only intended to assist understanding in the present disclosure, and do not belong to scope of protection of the present disclosure.

Embodiments of the present disclosure provide an AR spectacle, including a spectacle frame; and at least one optical waveguide, wherein an optical waveguide sheet of the optical waveguide is embedded in the spectacle frame.

The optical waveguide in this embodiment has the same structure as the optical waveguide provided in any one of above-described embodiments, and can bring about the same or similar technical effects. Details are not repeatedly described herein. For details, reference may be made to description of the above-described embodiments.

Above-described description is merely illustrative of preferred embodiments of the present disclosure and of technical principles applied thereto, as will be appreciated by those skilled in art, The disclosure of the present disclosure is not limited to technical solution formed by specific combination of described technical features, At the same time, it should also cover other technical solutions formed by any combination of the described technical features or equivalent features thereof without departing from described disclosed concept. For example, a technical solution formed by replacing above features with (but not limited to) technical features with similar functions disclosed in this disclosure.

What is claimed is:

1. A two-dimensional grating, comprising a plurality of sub-units, wherein the plurality of sub-units are arranged at intervals along a first direction, and the plurality of sub-units are arranged at intervals along a second direction, a set angle exists between the first direction and the second direction, and an angular bisector direction of the set angle coincides with a diffraction order direction required to be suppressed by the two-dimensional grating;
projections of two adjacent sub-units in any one of the first direction and the second direction in a direction perpendicular to the diffraction order direction are connected to each other and not overlapped.

2. The two-dimensional grating of claim 1, wherein each of the sub-units is a rectangular sub-unit, and the rectangular sub-unit comprises a long side and a short side that are perpendicular to each other;
the diffraction order direction required to be suppressed by the two-dimensional grating is a (1,1)-order diffraction order direction, and the long side is parallel to the (1,1)-order diffraction order direction of the two-dimensional grating.

3. The two-dimensional grating of claim 2, wherein projections of long sides of two adjacent sub-units in any one of the first direction and the second direction in a direction perpendicular to a (1,1)-order diffraction order direction of the two-dimensional grating are connected to each other and not overlapped.

4. The two-dimensional grating of claim 3, wherein in the first direction, the sub-units are arranged at equal intervals; in the second direction, the sub-units are arranged at equal intervals.

5. The two-dimensional grating of claim 3, wherein lengths of long sides of any two sub-units are equal, and lengths of short sides of any two sub-units are equal.

6. The two-dimensional grating of claim 2, wherein in the (1,1)-order diffraction order direction of the two-dimensional grating, a distance between two adjacent sub-units is equal to a length of a long side of each of the sub-units.

7. The two-dimensional grating of claim 1, wherein the first direction and the second direction are directions of two lattice vectors of a lattice of the two-dimensional grating.

8. The two-dimensional grating of claim 7, wherein an angle between the first direction and the second direction is 0° to 180°.

9. An optical waveguide, comprising an optical waveguide sheet, wherein the optical waveguide sheet comprises a coupling-in region and a coupling-out region; the coupling-out region is provided with a two-dimensional grating, the two-dimensional grating comprising a plurality of sub-units, wherein the plurality of sub-units are arranged at intervals along a first direction, and the plurality of sub-units are arranged at intervals along a second direction, a set angle exists between the first direction and the second direction, and an angular bisector direction of the set angle coincides with a diffraction order direction required to be suppressed by the two-dimensional grating;
projections of two adjacent sub-units in any one of the first direction and the second direction in a direction perpendicular to the diffraction order direction are connected to each other and not overlapped.

10. The optical waveguide of claim 9, wherein each of the sub-units is a rectangular sub-unit, and the rectangular sub-unit comprises a long side and a short side that are perpendicular to each other;
the diffraction order direction required to be suppressed by the two-dimensional grating is a (1,1)-order diffraction order direction, and the long side is parallel to the (1,1)-order diffraction order direction of the two-dimensional grating.

11. The optical waveguide of claim 10, wherein projections of long sides of two adjacent sub-units in any one of the first direction and the second direction in a direction perpendicular to a (1,1)-order diffraction order direction of the two-dimensional grating are connected to each other and not overlapped.

12. The optical waveguide of claim 11, wherein in the first direction, the sub-units are arranged at equal intervals; in the second direction, the sub-units are arranged at equal intervals.

13. The optical waveguide of claim 11, wherein lengths of long sides of any two sub-units are equal, and lengths of short sides of any two sub-units are equal.

14. The optical waveguide of claim 10, wherein in the (1,1)-order diffraction order direction of the two-dimensional grating, a distance between two adjacent sub-units is equal to a length of a long side of each of the sub-units.

15. The optical waveguide of claim 9, wherein the first direction and the second direction are directions of two lattice vectors of a lattice of the two-dimensional grating.

16. The optical waveguide of claim 14, wherein the (1,1)-order diffraction order direction of a two-dimensional grating is inclined to a horizontal direction.

17. The optical waveguide of claim 14, wherein the (1,1)-order diffraction order direction of a two-dimensional grating is perpendicular to a horizontal direction.

18. The optical waveguide of claim 15, wherein an angle between the first direction and the second direction is 0° to 180°.

19. The optical waveguide of claim 16, wherein an angle between the first direction and the second direction is equal to 90°.

20. An AR eyewear, comprising: a spectacle frame;
at least one optical waveguide of claim 9, wherein the optical waveguide sheet of the optical waveguide is embedded in the spectacle frame.
